(19) United States
(12) Patent Application Publication
(10) Pub. No.: US 2015/0200384 A1
(43) Pub. Date: Jul. 16, 2015

(54) ELECTRIC VEHICLE BATTERY CELL HAVING CONDUCTIVE CASE

(71) Applicant: Ford Global Technologies, LLC, Dearborn, MI (US)

(72) Inventors: Philip Michael Gonzales, Dearborn, MI (US); Mary Casci, Beavercreek, OH (US)

(21) Appl. No.: 14/154,270

(22) Filed: Jan. 14, 2014

(51) Int. Cl. H01M 2/02; H01M 10/04

(52) U.S. Cl. CPC H01M 2/0285; H01M 10/0431; H01M 2/0262; H01M 2220/20

(57) ABSTRACT

An example battery cell for an electric vehicle includes at least one conductive case, and an electrode structure in direct electrical contact with the at least one conductive case. The electrode structure is to selectively provide power to an electric vehicle.

### BACKGROUND

This disclosure relates generally to a case and, more particularly, to an electric vehicle battery cell having a conductive case.

Generally, electric vehicles differ from conventional motor vehicles because electric vehicles are selectively driven using one or more battery-powered electric machines. Conventional motor vehicles, by contrast, rely exclusively on an internal combustion engine to drive the vehicle. Electric vehicles may use electric machines instead of, or in addition to, the internal combustion engine.

Example electric vehicles include hybrid electric vehicles (HEVs), plug-in hybrid electric vehicles (PHEVs), fuel cell vehicles, fuel cell electric vehicles, and battery electric vehicles (BEVs). A powertrain of an electric vehicle is typically equipped with a battery that stores electrical power for powering the electric machine. The battery may be charged prior to use. The battery may be recharged during a drive by regeneration braking or an internal combustion engine.

The battery may include multiple battery cells each having internal electrode structures. Components, such as terminals, carry power from the electrode structures to outside the battery cells. A bus bar may connect the terminals. Assembling the many components of the battery is time consuming and costly.

### SUMMARY

An electric vehicle battery cell according to an exemplary aspect of the present disclosure includes, among other things, a battery cell having at least one conductive case, and an electrode structure in direct electrical contact with the at least one conductive case. The electrode structure selectively provides power to an electric vehicle.

In another example of the foregoing electric vehicle battery cell, the at least one case comprises a first conductive case and a second conductive case. The electrode structure is sandwiched between the first conductive case and the second conductive case.

In yet another example of any of the foregoing electric vehicle battery cells, the first conductive case and the second conductive case are interchangeable with each other.

In yet another example of any of the foregoing electric vehicle battery cells, a spacer electrically separates the first conductive case from the second conductive case.

In yet another example of any of the foregoing electric vehicle battery cells, the first conductive case, the second conductive case, and the spacer provide a cavity to receive the electrode structure.

In yet another example of any of the foregoing electric vehicle battery cells, the spacer provides a first groove to receive a wall of the first conductive case and a second groove to receive a second wall of the second conductive case.

In yet another example of any of the foregoing electric vehicle battery cells, the first conductive case and the second conductive case each comprise a plurality of walls extending away from a floor.

In yet another example of any of the foregoing electric vehicle battery cells, at least one wall of the first conductive case overlaps at least one wall of the second conductive case when the cell is assembled.

In yet another example of any of the foregoing electric vehicle battery cells, the electrode structure has a jelly-roll configuration.

In yet another example of any of the foregoing electric vehicle battery cells, the cell includes no terminals.

In yet another example of any of the foregoing electric vehicle battery cells, the cell is a portion of an electric vehicle powertrain.

An electric vehicle battery according to another example aspect of the present disclosure, a plurality of battery cells are arranged in series to selectively power an electric vehicle. Each of the battery cells has at least one conductive case in electrical contact with an electrode.

In yet another example of the foregoing electric vehicle battery, the plurality of battery cells are compressed.

In yet another example of any of the foregoing electric vehicle batteries, the electric vehicle battery includes no terminals.

In yet another example of any of the foregoing electric vehicle batteries, the at least one conductive case comprises a positive case and a negative case, the positive case of one of the plurality of battery cells is in direct electrical contact with the negative case of another one of the plurality of battery cells.

In yet another example of any of the foregoing electric vehicle batteries, the positive case and the negative case are interchangeable.

A method of conducting power within an electric vehicle battery according to yet another exemplary aspect of the present disclosure, includes, among other things, positioning an electrode structure between a first conductive case and a second conductive case. The method communicates power to and from the electrode structure using the first or second conductive case.

In another example of the foregoing method, the method includes electrically isolating the first and second conductive cases from each other using a spacer having grooves that each receive respective walls of the first and second conductive cases.

In another example of the foregoing method, the method includes directly contact opposing sides of the electrode structure with the conductive cases.

### DESCRIPTION OF THE FIGURES

The various features and advantages of the disclosed examples will become apparent to those skilled in the art from the detailed description. The figures that accompany the detailed description can be briefly described as follows:

FIG. 1 illustrates a schematic view of a powertrain of an example electric vehicle.

FIG. 2 shows an example battery pack having a plurality of battery cells.

FIG. 3 shows an exploded view of one of the battery cells of FIG. 2.

FIG. 4 shows a cross-section view through one of the battery cells of FIG. 2.

### DETAILED DESCRIPTION

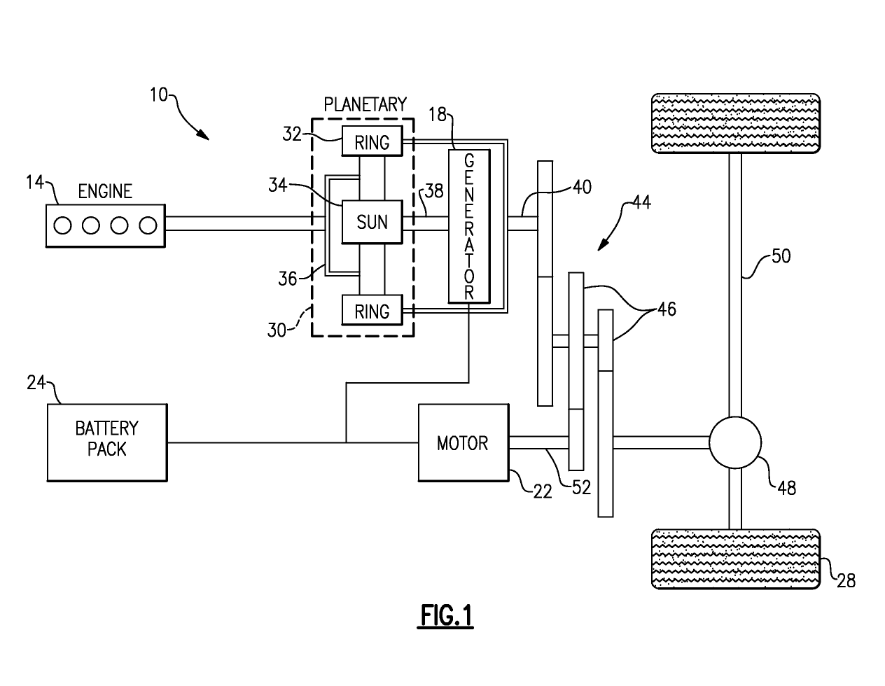

FIG. 1 schematically illustrates a powertrain 10 for an electric vehicle. Although depicted as a hybrid electric vehicle (HEV), it should be understood that the concepts described herein are not limited to HEVs and could extend to other electrified vehicles, including, but not limited to, plug-in hybrid electric vehicles (PHEVs), fuel cell electric vehicles, and battery electric vehicles (BEVs).

In one embodiment, the powertrain 10 is a powersplit powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery pack 24. In this example, the second drive system is considered an electric drive system of the powertrain 10. The first and second drive systems generate torque to drive one or more sets of vehicle drive wheels 28 of the electric vehicle.

The engine 14, which is an internal combustion engine in this example, and the generator 18 may be connected through a power transfer unit 30, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear 32, a sun gear 34, and a carrier assembly 36.

The generator 18 can be driven by engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In this example, the second power transfer unit 44 is mechanically coupled to an axle 50 through the differential 48 to distribute torque to the vehicle drive wheels 28.

The motor 22 (i.e., the second electric machine) can also be employed to drive the vehicle drive wheels 28 by outputting torque to a shaft 52 that is also connected to the second power transfer unit 44. In one embodiment, the motor 22 and the generator 18 cooperate as part of a regenerative braking system in which both the motor 22 and the generator 18 can be employed as motors to output torque. For example, the motor 22 and the generator 18 can each output electrical power to the battery pack 24.

The battery pack 24 is an example type of electric vehicle battery assembly. The battery pack 24 may have the form of a high voltage battery that is capable of outputting electrical power to operate the motor 22 and the generator 18. Other types of energy storage devices and/or output devices can also be used with the electric vehicle having the powertrain 10.

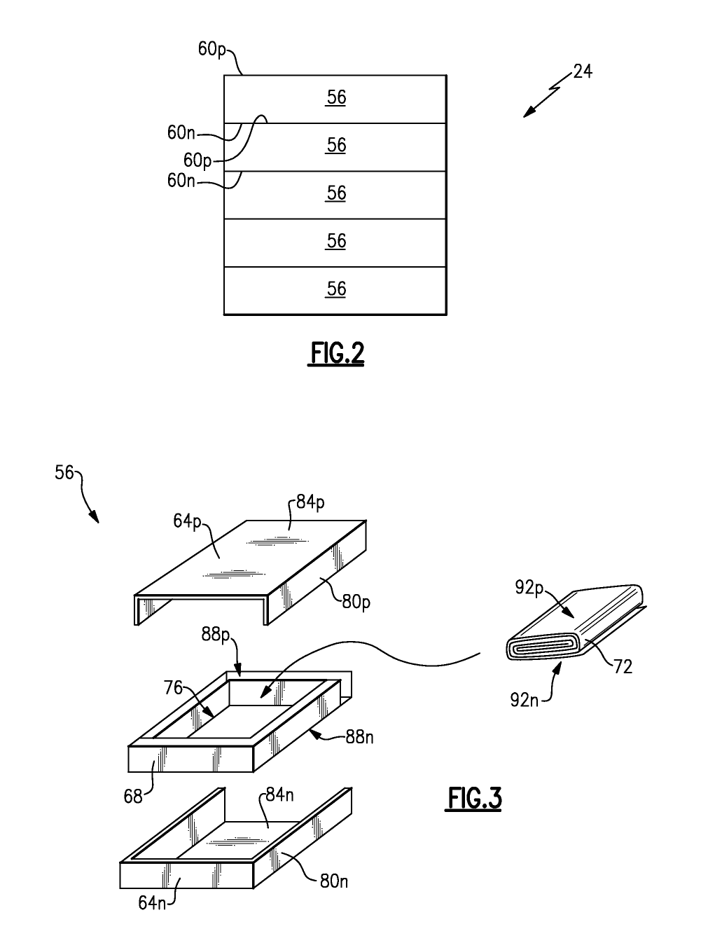

Referring now to FIG. 2 with continued reference to FIG. 1, the battery pack 24 includes a plurality of individual battery cells 56. The total number of cells 56 may be increased or decreased to provide an appropriate voltage range for the powertrain 10. In one example, the battery pack 24 includes enough cells 56 to provide about 300 volts. Notably, the example battery pack 24 includes no terminals. A bus bar, such as a copper bus bar may be electrically coupled to the battery cells 56 to carry power to and from the battery pack 24.

The cells 56 each include a positive side 60p having a positive polarity and a negative side 60n having a negative polarity. Within the example battery pack 24, the cells 56 are stacked in series such that the positive sides 60p of one of the cells 56 contacts the negative sides 60n of an adjacent cell 56. The cells 56 of the battery pack 24 can be compressed to ensure the adjacent cells contact each other.

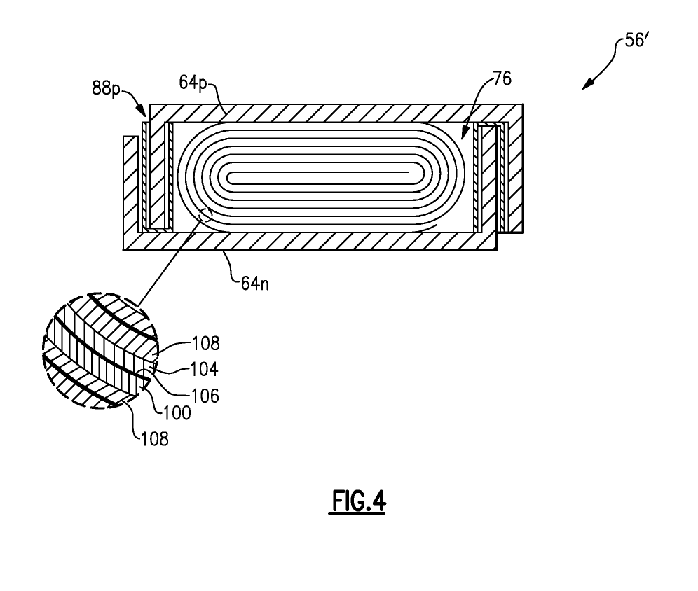

Referring now to FIGS. 3 and 4 with continuing reference to FIG. 2, in an example of one of the battery cells 56′, the battery cell 56′ includes a positive case 64p, a negative case 64n, a spacer 68, and an electrode structure 72. In the assembled cell 56′, the positive case 64p, the negative case 64n, and the spacer 68 together provide a cavity 76 to receive the electrode structure 72. The positive case 64p and the negative case 64n sandwich the electrode structure 72. The spacer 68 prevents or substantially prevents electrical contact between the positive case 64p and the negative case 64n.

In this example, the positive case 64p includes walls 80p extending from a floor 84p. The negative case 64n includes walls 80n extending from a floor 84n. The positive case 64p and the negative case 64n each include a back wall and two side walls in this example.

The spacer 68 provides a groove 88p to receive at least some of the walls 80p. The spacer 68 further provides a groove 88n to receive at least some of the walls 80n. The groove 88p of the example spacer 68 receives a portion of one side wall and a portion of the back wall of the positive case 64p. The groove 88n receives a portion of one side wall and a portion of the back wall of the negative case 64n.

When assembled, the walls of the positive case 64p overlap the walls of the negative case 64n but the spacer 68 prevents such contact.

The example cases 64p and 64n are stamped from sheets of a planar metal or metal-based material. The example cases 64p and 64n are also interchangeable. That is, the dimensions of the cases 64p and 64n are effectively the same. Thus, both cases 64p and 64n can be manufactured utilizing the same equipment. Designing the cases 64p and 64n to be interchangeable can save manufacturing costs, as unique tooling and machinery are not required to produce each of the cases 64p and 64n.

The electrode structure 72 has a jelly-roll configuration in this example. A positive side 92p of the electrode structure 72 has a positive polarity and an opposing, negative side 92n of the electrode structure 72 has a negative polarity.

The electrode structure 72 is provided by a multilayered material that is folded and wound to provide the electrode structure 72 jelly-roll. The electrode structure 72 includes a cathode layer 100, an anode layer 104, an isolation barrier 106, and an insulative barrier 108. The isolation barrier 106 separates the cathode layer 100 from the anode layer 104. The insulative barrier 108 covers the contacting cathode and anode layers 100 and 104.

At an outer region of the electrode assembly 72, some of the layers are removed to provide the positive polarity for the side 92p and the negative polarity for the side 92n. More specifically, in this example, an outermost layer of the insulative barrier 108 is removed to expose the cathode layer 100 and provide the positive polarity for the side 92p. On the other outermost side of the electrode structure 72, the outermost insulative barrier 108 and the cathode layer 100 are removed to expose the anode layer 104 and provide the negative polarity for the side 92n.

When the electrode structure 72 is positioned within the assembled battery cell 56′, the positive side 92p of the electrode structure 72 is in direct electrical contact with the positive case 64p, and particularly the floor 84p of the positive case 64p. The negative side 92n of the electrode structure 72 is in direct electrical contact with the negative case 64n, and particularly the floor 84n of the negative case. Direct electrical contact between the electrode structure 72 and the cases 64p and 64n makes the cases 64p and 64n conductive. Because the cases 64p and 64n are conductive, separate terminal assemblies or other structures for carrying power from the electrode structure 72 are not required.

In this example, both of the cases 64p and 64n are conductive. In other examples, only one of the cases is conductive and the other case is replaced by a terminal.

The electrode structure 72 could have several different configurations. The electrode structure 72 could be an ultra-capacitor, for example, rather than a wound jelly-roll. The ultra-capacitor could have a single large anode and a single large cathode each in contact with one of the cases 64p and 64n.

Features of the disclosed examples include a battery cell that uses fewer terminals than prior art designs. The battery cell may include no terminals. The battery cell has a reduced assembly time and utilizes less fasteners than previous designs, which saves assembly time, fastener costs, and tooling costs.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. A battery cell, comprising:
at least one conductive case; and
an electrode structure in direct electrical contact with the at least one conductive case, the electrode structure to selectively provide power to an electric vehicle.

2. The cell of claim 1, wherein the at least one case comprises a first conductive case and a second conductive case, the electrode structure sandwiched between the first conductive case and the second conductive case.

3. The cell of claim 2, wherein the first conductive case and the second conductive case are interchangeable with each other.

4. The cell of claim 2, including a spacer to electrically separate the first conductive case from the second conductive case.

5. The cell of claim 4, wherein the first conductive case, the second conductive case, and the spacer provide a cavity to receive the electrode structure.

6. The cell of claim 4, wherein the spacer provides a first groove to receive a wall of the first conductive case and a second groove to receive a second wall of the second conductive case.

7. The cell of claim 2, wherein the first conductive case and the second conductive case each comprise a plurality of walls extending away from a floor.

8. The cell of claim 7, wherein at least one wall of the first conductive case overlaps at least one wall of the second conductive case when the cell is assembled.

9. The cell of claim 1, wherein the electrode structure has a jelly-roll configuration.

10. The cell of claim 1, wherein the cell includes no terminals.

11. The cell of claim 1, wherein the cell is a portion of an electric vehicle powertrain.

12. A electric vehicle battery, comprising:
a plurality of battery cells arranged in series to selectively power an electric vehicle, each of the battery cells having at least one conductive case in electrical contact with an electrode.

13. The electric vehicle battery of claim 12, wherein the plurality of battery cells are compressed.

14. The electric vehicle battery of claim 12, wherein the electric vehicle battery includes no terminals.

15. The electric vehicle battery of claim 12, wherein the at least one conductive case comprises a positive case and a negative case, the positive case of one of the plurality of battery cells in direct electrical contact with the negative case of another one of the plurality of battery cells.

16. The electric vehicle battery of claim 15, wherein the positive case and the negative case are interchangeable.

17. A method of conducting power within an electric vehicle battery, comprising:
positioning an electrode structure between a first conductive case and a second conductive case; and
communicating power to and from the electrode structure using the first or second conductive case.

18. The method of claim 17, electrically isolating the first and second conductive cases from each other using a spacer having grooves that each receive respective walls of the first and second conductive cases.

19. The method of claim 18, including directly contact opposing sides of the electrode structure with the first and second conductive cases.
